(19) United States
(12) Patent Application Publication
(10) Pub. No.: US 2026/0165379 A1
(43) Pub. Date: Jun. 18, 2026

(54) HEATER FOR AN AEROSOL PROVISION DEVICE

(71) Applicant: Nicoventures Trading Limited, London (GB)

(72) Inventors: Tom WOODMAN, London (GB); Juan Esteban PAZ JAUREGUI, London (GB); Mark POTTER, London (GB); Theodora NANNOU, London (GB)

(21) Appl. No.: 19/125,208

(22) PCT Filed: Oct. 30, 2023
(86) PCT No.: PCT/EP2023/080272

§ 371 Date: Apr. 28, 2025

(30) Foreign Application Priority Data
Oct. 31, 2022 (GB) 2216115.2

(51) Int. Cl. A24F 40/46; A24F 40/70; H05B 3/44

(52) U.S. Cl. CPC A24F 40/46; A24F 40/70; H05B 3/44

(57) ABSTRACT

A heater for an aerosol provision device configured to heat an article containing aerosol generating material is disclosed. The heater includes an elongate housing with an inner surface, and a heating coil in the housing. The heating coil comprises a length of heating material shaped into a coil, and a surface of the length of the heating material comprises a first area, a second area, and a third area. The first area comprises the part of the surface which could touch the inner surface of the housing when the heating coil is located within the inner housing. The second area comprises a part of the surface which could touch another part of the surface of the heating material when the heating coil is located within the inner housing.

### CROSS-REFERENCE TO RELATED APPLICATIONS

This present application is a National Phase entry of PCT Application No. PCT/EP2023/080272, filed Oct. 30, 2023, which claims priority from GB 2216115.2, filed Oct. 31, 2022, each of which are fully incorporated herein by reference in their entireties.

### TECHNICAL FIELD

The present invention relates to a heater for an aerosol provision device, an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately, induction heating systems are known to be used as heaters.

### SUMMARY

According to an aspect there is provided a heater for an aerosol provision device configured to heat an article containing aerosol generating material. The heater comprises an elongate housing with an inner surface and a heating coil in the housing. The heating coil comprises a length of heating material shaped into a coil, and the surface of the length of the heating material comprises a first area, a second area, and a third area. The first area is or includes the part of the surface of the length of heating material which could touch the inner surface of the housing when the heating coil is located within the inner housing, the second area is or includes a part of the surface which could touch another part of the surface of the length of heating material when the heating coil is located within the inner housing, and the third area comprises the part of the surface of the length of heating material which could not touch either of the inner surface of the housing or another part of the surface of the length of heating material when the heating coil is located within the inner housing. At least one of the first and second areas supports an electrical insulator, and at least part of the third area does not support/is free of an electrical insulator.

According to an aspect there is provided a heater for an aerosol provision device configured to heat an article containing aerosol generating material. The heater comprises an elongate housing with an inner surface, and a heating coil in the housing. The heating coil comprises a length of heating material shaped into a coil, and the surface of the length of the heating material comprises a first surface area, a second surface area, and a third surface area. An electrical insulator is provided on at least one of the first surface area and the second surface area of the heating material, and the third surface area of the heating material is spaced from the inner surface of the length of housing and is free from an electrical insulator.

The first, second and third areas of the surface of the length of heating material are longitudinally extending along the length of heating material.

The elongate housing may include a bore, and the surface of the bore defines an inner void. The heating coil may be located in that inner void.

The heating coil may be longitudinally extending. The heating coil may be formed from a plurality of loops or turns of the heating material. The coil may have a longitudinal axis about which the loops or turns of the coil extend.

The heating coil may be a helical coil or similar to a helical coil.

Both side areas may support the electrical insulator.

In an embodiment of any of the above embodiments, both of the first and second areas may support the electrical insulator.

The electrical insulator may space the first surface area of the length of the heating material from the inner surface of the housing.

The electrical insulator may space each part of the second surface area of the heating material from at least one of each other part of the second surface area, the first surface area, and the third surface area of the heating material.

The first and second areas may be contiguous. In some embodiments the electrical insulator supported on the first and second areas is continuous over both areas.

The electrical insulator may be a dielectric material.

The dielectric material may be one of a ceramic material, a glass, a plastic, or a metal oxide.

The heater may be a resistive heating heater. The length of heating material may be a length of resistive heating material.

The elongate housing may comprise an outer surface; in which at least a part of the outer surface of the elongate housing supports a low friction material. The low friction material may have a lower coefficient of friction than the outer surface of the housing.

At least 50% of the area of the outer surface of the housing supports the low friction material.

At least 70% of the area of the outer surface of the housing may support the low friction material.

At least 90% of the area of the outer surface of the housing may support the low friction material.

The outer surface of the housing may have a coefficient of friction of less than 1.4, of less than 0.7 or of less than 0.15.

The low friction material may comprise one or more of a diamond-like-carbon (DLC), copper, glass, graphite, aluminium and aluminium magnesium boride (BAM).

According to an aspect there is provided a length of heating material for use in making a heater coil for use in a heater as described above. An electrical insulator is supported on at least one longitudinally extending area of the surface of the length of heating material, and at least one longitudinally extending area of the surface of the length of heating material is free from/does not support an electrical insulator. The at least one longitudinally extending area on which the electrical insulator is supported is so dimensioned and positioned on the surface of the length of heating material that when the length of heating material is formed into a coil having a longitudinal extent the electrical insulator can be positioned relative to the coil so that the electrical insulator spaces the heating material from one or both of an adjacent turn of the coil, and a flat surface outside the coil that extends in a direction parallel to the longitudinal extent of the coil.

The at least one longitudinally extending area of the surface of the length of heating material that supports the electrical insulator may comprise two non-contiguous longitudinally extending areas of the surface of the length of heating material.

The length of heating material may have a longitudinally extending axis. The two longitudinally extending areas of the surface of the length of heating material that support the electrical insulator may each have a longitudinally extending axis. The longitudinally extending axes of the areas of the surface of the length of heating material that support the electrical insulator may be angularly spaced from each other around the longitudinally extending axis of the length of heating material by at least one of between 65 and 115 degrees, between 75 and 105 degrees, between 80 and 100 degrees, and between 85 and 95 degrees.

The at least one longitudinally extending area of the surface of the length of heating material to which the electrical insulator is applied may have a total area of less than or equal to 55% of the total surface area of the length of heating material.

The length of heating material may be a length of a resistive heating material.

According to an aspect there is provided a method of making a length of heating material as described above. In the method a length of heating material is provided, and an electrical insulator is applied to at least one longitudinally extending area of the surface of the length of heating material whilst keeping at least one longitudinally extending area of the surface of the length of heating material free from electrical insulator. The length of heating material is shaped into a coil.

The electrical insulator is applied to the at least one longitudinally extending area during the process of shaping the length of heating material into the coil.

The electrical insulator is applied as a liquid coating.

The electrical insulator is applied as a part of a plating process.

The electrical insulator is applied as a part of a vapour deposition process.

The electrical insulator is applied as a part of an anodising process.

The at least one longitudinally extending area of the surface of the length of heating material to which the electrical insulator is applied totals less than or equal to 55% of the total surface area of the length of heating material.

The at least one longitudinally extending area of the surface of the length of heating material to which the electrical insulator is applied comprises two non-contiguous longitudinally extending areas of the surface of the length of heating material.

The heater may be an inductive heating heater. The length of heating material may be an inductive length of heating material. The coil may be an inductive coil.

According to an aspect, there is provided aerosol provision device configured to heat an article comprising aerosol generating material, the device comprising a heater as described above.

The aerosol provision device may comprise a heating chamber, in which the heater is provided.

The aerosol provision device may comprise a power source, a controller and a heating chamber, in which the aerosol generating article is removeable received.

The power source may be aligned along a longitudinal axis of the heating chamber.

The power source may be aligned along a second longitudinal axis, parallel to the longitudinal axis of the heating chamber.

The aerosol provision device may be configured for wireless charging.

The aerosol provision device may be provided with a charging port, such as a USB port, which is used to couple the power supply to an external power source for recharging.

According to an aspect there is provided an aerosol provision system comprising: an aerosol provision device as described above; and an article comprising aerosol generating material.

The aerosol provision system may comprise a charging unit having a cavity for removably receiving the aerosol provision device.

The charging unit may comprise a moveable lid, which covers the aerosol provision device in a closed configuration.

The charging unit may comprise a user display.

The user display may be visible to a user when the moveable lid is in a closed position and is partially or fully concealed or obscured from sight by the lid when the lid is an open position.

According to another aspect there is provided a method of generating aerosol comprising: providing an aerosol provision device comprising a heater as described above and a heating chamber including a receiving portion, and at least partially inserting an aerosol generating article into the receiving portion of the heating chamber.

The heater, length of heating material, and device aspects of the present disclosure as described above can include one or more, or all, of the features or embodiments described above, or combinations of embodiments as appropriate. The method aspects of the present disclosure can include one or more, or all, of the features or embodiments as described above, as appropriate

### BRIEF DESCRIPTION OF THE DRAWINGS

Various embodiments will now be described, by way of example only, and with reference to the accompanying drawings, in which:

FIG. 1 shows a perspective view of an aerosol provision system including an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a perspective view of another aerosol provision device;

FIG. 5 shows a schematic cross-sectional view of the device of FIG. 4;

FIG. 6 shows a schematic cross-sectional view of a heater of the device of FIG. 1 or FIG. 4;

FIG. 7 shows a schematic view of a detail of a first embodiment of a heater of FIG. 6;

FIG. 8 shows a second schematic view of a detail of a first embodiment of a heater of FIG. 6;

FIG. 9 shows a schematic view of a detail of a second embodiment of a heater of FIG. 6;

FIG. 10 shows a second schematic view of a detail of a second embodiment of a heater of FIG. 6;

FIG. 11 shows a third schematic view of a detail of a second embodiment of a heater of FIG. 6; and

FIG. 12 shows a fourth schematic view of a detail of a second embodiment of a heater of FIG. 6.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area or volume for receiving the consumable, an aerosol generator, an aerosol generation area or volume, a housing, a mouthpiece, a filter and/or an aerosol-modifying agent.

In some embodiments, the consumable for use with the non-combustible aerosol provision device may comprise aerosol-generating material, an aerosol-generating material storage area or volume, an aerosol-generating material transfer component, an aerosol generator, an aerosol generation area or volume, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourant.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

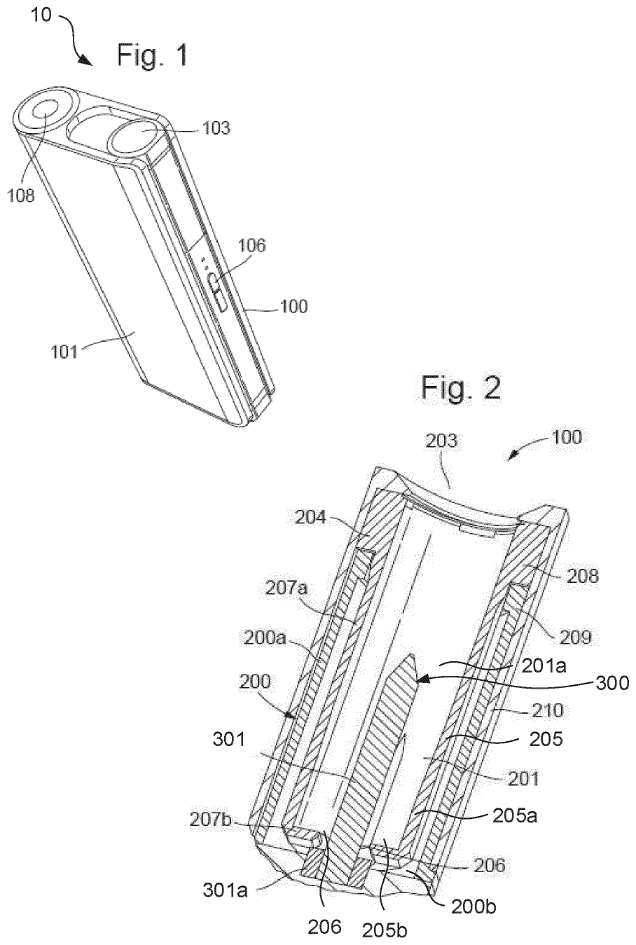

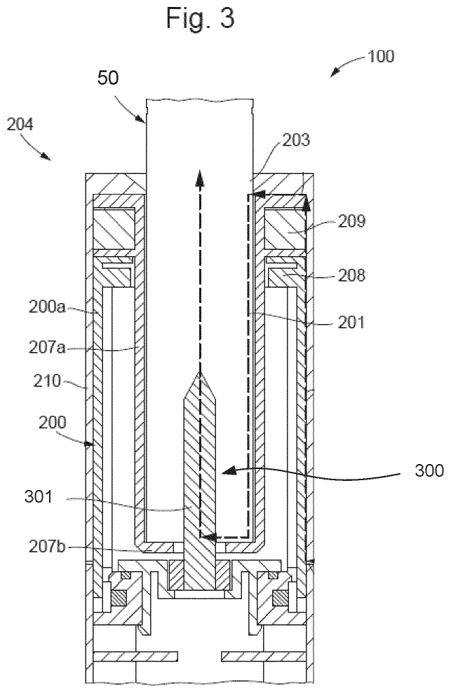

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity (refer to FIG. 2) for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 shows a cross sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured at least a portion of the article for heating.

A heater 301 is provided in a portion of the main housing 200 and the heater 301 extends or projects into the heating chamber 201. The heater 301 may comprise a base portion 301a which may be located in a recess provided in a portion of the body of the device 100. The heater 301 upstands in the heating chamber 201. The heater 301 upstands from the distal end.

The heater 301 comprises an elongate heater in the form of a pin. The heater 301 in other embodiments comprises other elongate configurations, such as a blade. The heater 301 may be inserted, in use, into a distal end of an aerosol generating article 50 (refer to FIG. 3) which is received within the heating chamber 201 in order to internally heat the aerosol generating article.

The housing comprises housing wall 200a. The housing wall 200a extends along the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heater 301 upstands from the housing base 200b. The heater 301 protrudes through the receptacle base 205b. An aperture 206 is formed in the receptacle base 205b through which the heater 301 protrudes. In embodiments, the heater 301 is mounted to the receptacle base 205b. The heater 301 upstands from the receptacle base 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heater 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of a rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heater 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding). Alternatively, the tubular portion 207a and base portion 207b may comprise a first component and the outer cap portion 210 may comprise a second separate component. The first and second components may then be secured together.

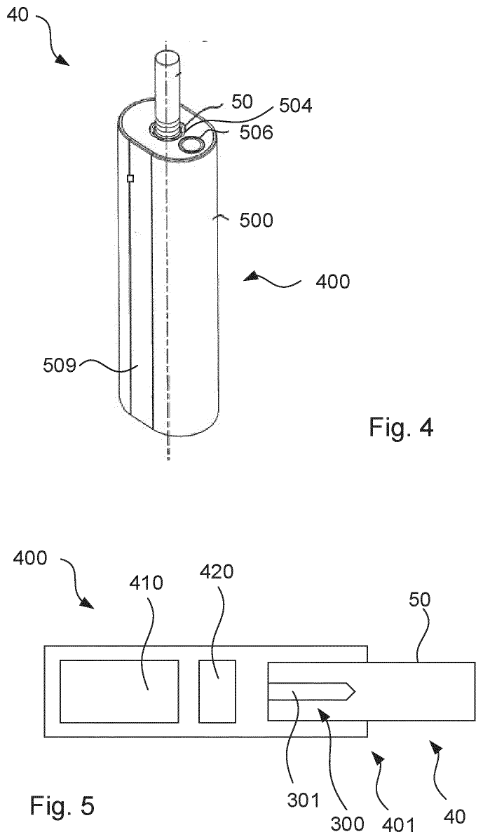

FIG. 4 shows another aerosol provision system 40. The system 40 comprises a one-piece aerosol provision device 400 for generating aerosol from an aerosol generating material, and the aerosol generating article 50 comprising the aerosol generating material. The device 400 can be used to heat the aerosol generating article 50 comprising the aerosol generating material, to generate an aerosol or other inhalable material which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 406.

The device 400 defines a longitudinal axis 509 along which an article 50 may extend when inserted into the device 400. The opening 504 is aligned on the longitudinal axis 509.

FIG. 5 shows a cross-sectional schematic view of the aerosol provision system 40. Features described with reference to FIG. 5 in embodiments are applicable to embodiments described above. The aerosol generating device comprises a power source 410, a controller 420 and a heating chamber 401, in which the aerosol generating article 50 is removably received.

The one-piece device of FIG. 5 shows the power source 410 aligned along the longitudinal axis of the heating chamber 401. In another embodiment of a one-piece aerosol generating device, the power source is aligned along a second longitudinal axis, parallel to the longitudinal axis of the heating chamber.

The heater 301 comprises an elongate heater in the form of a pin. The heater 301 in embodiments comprises other elongate configurations, such as a blade. The heater 301 is provided in the heating chamber. The heater 301 of FIG. 5 and the heater 301 described above with reference to FIGS. 1 to 3, such that details described herein may be applied to each. The heater 301 extends or projects into the heating chamber 401.

The heater 301 may be inserted, in use, into a distal end of the aerosol generating article which is received within the heating chamber 401 in order to internally heat the aerosol generating article.

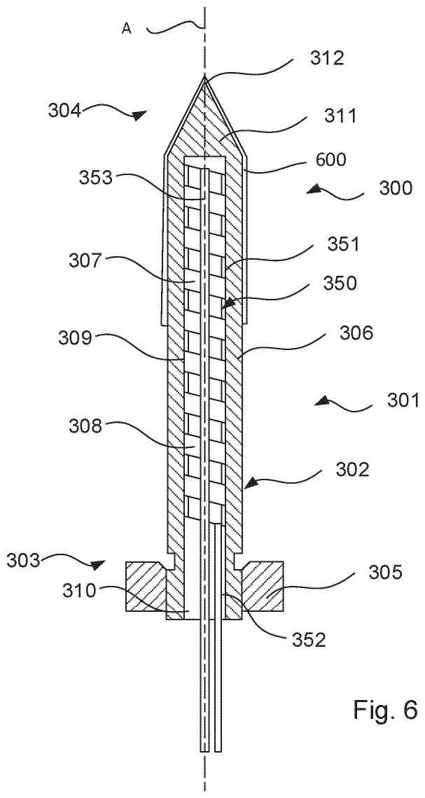

The aerosol provision devices 100, 400 comprise a heating arrangement 300. The heating arrangement 300 comprises a heater. The heater 301 comprises a heating element 350 (refer to FIG. 6), such as a resistive heating coil, arranged to be actuated to heat the heater 301.

The heating arrangement 300 is a resistive heating arrangement. The heater is a resistive heating heater. The heating element, such as a heating coil, as will be described below is a resistive heating element. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heater itself. In embodiments the resistive heating element transfers heat to the heater, for example by conduction. The provision of a resistive heating arrangement allows for a compact arrangement. Resistive heating provides an efficient configuration.

FIG. 6 shows the heater 301 for use in an aerosol provision device as described above. The heating arrangement 300 comprises the heater 301. The heater 301 comprises an elongate housing 302 and the heating element 350. The elongate housing 302 is an elongate member defining a longitudinal axis A.

The elongate housing 302 is formed from a thermally conductive material, such as stainless steel. The elongate housing has a low friction coating 600 on part of its outer surface 313. The coating 600 has a coefficient of friction lower than the coefficient of friction of the surface 313 of the elongate housing 302.

In embodiments, the outer surface 313 has a coefficient of friction of less than 1.4, of less than 0.7 or of less than 0.15. The low friction coating 600 in embodiments forms the outer surface 313. In embodiments, the low friction coating 600 is, for example, diamond-like-carbon (DLC). Other suitable materials include copper, glass, graphite, aluminium and aluminium magnesium boride (BAM). In embodiments, the low friction coating 600 comprises copper and the main body of the housing 302 comprises glass. In embodiments, the low friction coating 600 comprises one of glass or diamond-like-carbon (DLC) and the main body of the housing 302 comprises a metal, such as aluminium. In embodiments, the low friction coating 600 comprises aluminium and the main body of the housing 302 comprises a ceramic. Other combinations of materials are, however, envisaged. The provision of a low friction outer surface aids with restricting one or more components of the article, such as glycerol, adhering to the surface and diminishing the performance of the heater over time.

The elongate housing 302 is configured to transfer heat from the heating element 350 to the heating zone 201a.

The elongate housing 302 has a base end 303 and a free end 304. The base end 304 mounts to the device body. A mount 305 at the base end 303 mounts the heater 301. It will be understood that different mounting arrangements may be used, for example a fixing, moulding, and bonding including adhering. The mount 305 may be a separate component or may be integrally formed with the elongate housing 302.

The elongate housing 302 comprises a housing body 306. The housing body 306 is tubular. The housing body 306 comprises a bore 307. The bore 307 defines an inner void 308 of the heater 301. The inner void 308 extends longitudinally. In embodiments, the inner void 308 is at least partially filled, for example with a filler. In embodiments, the inner void 308 is completely filled, for example with one or more fillers and/or components. In embodiments, the inner void 308 defines an air gap. An inner surface 309 is defined on an inner side of the elongate housing 302. An open end 310 to the inner void 308 is provided at the base end 303.

The free end 304 of the elongate housing 302 extends towards the proximal end of the heating chamber. The free end 304 of the heater 301 is closed. The inner void 308 does not extend through the free end 304. A tip 311 is provided at the free end 304. The tip 311 extends to an apex 312. Other shapes and configurations of the tip 311 may be provided, for example the tip 311 may define a planar surface.

The heating element 350 extends in the heater 301. The heating element 350 extends in the elongate housing 302 in the longitudinal direction. The heating element 350 is received in the inner void 308. The heating element 350 extends between the base end 303 and the distal end 304. In embodiments, the heating element extends partially along the length of the inner void 308. In embodiments the heating element 350 extends to or beyond the open end 310. The heating element 350 in embodiments comprises a heating coil 351.

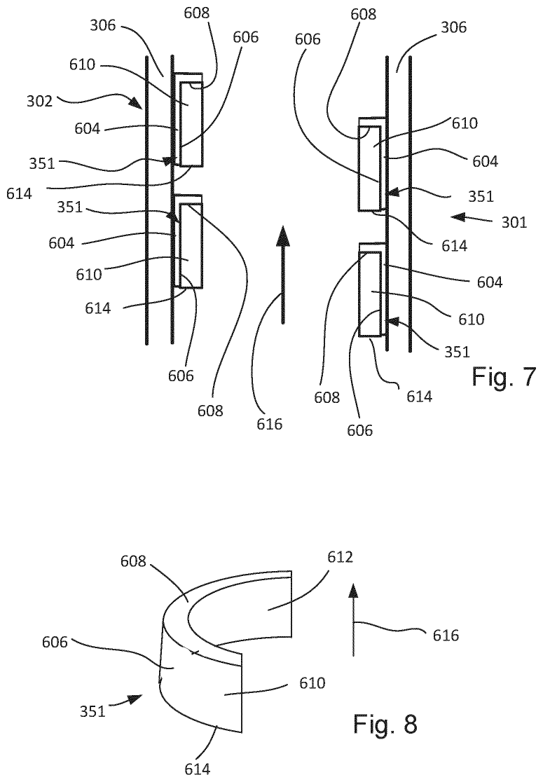

With reference to FIGS. 7 and 8, FIG. 7 shows a sectional detail of first embodiment of the heating coil 351 within part of the elongate housing 302. The section passes through the axis A of the elongate housing 302. FIG. 8 shows a perspective view of part of the coil 351.

The heating coil 351 is formed from a length of heating material 610 which has a rectangular cross-sectional profile. The length of heating material 610 has a first face 606 which forms the radially outermost face of the coil 351, a second face 608 which faces the adjacent turn or loop of the coil 351 in the direction of the arrow 616, a third face 612 which faces radially inwards into the coil 351, and a fourth face 614 which faces the adjacent turn or loop of the coil 351 in the opposite direction to arrow 616.

The first face 606 of the length of heating material 610 is the first area because, as may be seen in FIG. 7, the first face 606 is the part of the coil 351 that could touch the housing body 306 unless prevented from doing so.

The second face 608 of the length of heating material 610 is the second area because, as may be seen in FIG. 7, the second and fourth faces 608, 614 could touch each other if the coil 351 were subject to a longitudinal force in the direction of arrow 616 or the opposite direction. In other embodiments the fourth face 614 is the second area.

Supported on the first and second faces 606, 608 is an electrical insulator 604. The electrical insulator 604 prevents the first face 606 touching the housing body 306 and the second face 608 from touching the fourth face 614.

The third and fourth faces 612, 614 of the length of heating material 610 are the third surface area and do not support/are free of any electrical insulator 604.

When the coil is within the elongate housing, the coil is considered to be at low risk of significant damage or dimensional distortion from external forces. The coil may, however, move laterally within the housing and/or be subject to longitudinal forces that may cause the adjacent turns of the coil to move towards each other. Potentially such longitudinal forces may cause adjacent turns of the coil to move relative to each other and abut each other if there is sufficient movement. Such lateral and or longitudinal movement may be the result of thermal expansion when the heater of the present disclosure is in use.

The lateral movement of the coil may cause the radially outermost part of the coil to abut and touch the surface of the elongate housing. That radially outermost part of the coil is a longitudinally extending area along the length of heating material, and that area is the first area of the surface or is included in the first area of the surface. Because there is a low likelihood of significant damage or dimensional distortion to the coil when it is in the elongate housing, no other parts of the length of heating material could abut and touch the surface of the elongate housing.

The size of the area formed by the radially outermost part of the coil is determined by the cross-section of the length of heating material and the orientation of that cross-section. For example, a square cross-sectioned length of heating material with the sides of the square being either parallel or perpendicular to the surface of the elongate housing would result in a much larger area which could contact the elongate housing than a circular cross-sectioned length of heating material.

Supporting the electrical insulator on the first area of the surface of the length of heating material has the effect that the length of heating material is spaced from the surface of the elongate heater and no electric current will be able to travel between the length of heating material and the elongate housing.

The longitudinal movement of the turns of the coil may cause adjacent turns to contact each other. This has the result that for most of the length of the heating material there are two parts of the surface of the length of heating material that could touch another part of the surface of the length of heating material, those parts are on opposite sides of the length of heating material and each are a longitudinally extending side areas along the length of heating material. One of those side areas is the second area of the surface or is included in the second area of the surface.

When the electrical insulator is supported on the second area of the surface the side areas on adjacent turns of the coil are spaced from each other and electric current cannot travel from one turn to the next turn other than by passing along the length of heating material.

An advantage of the heater of the present disclosure is that the use of the electrical insulator on only part of the surface of the length of heating material reduces the amount of energy required to heat the coil relative to a coil formed from a length of heating material that is fully insulated. This increases the amount of use that can be made of a device incorporating the heater of the present disclosure between recharges (in the case of a device that is rechargeable) or between changing batteries

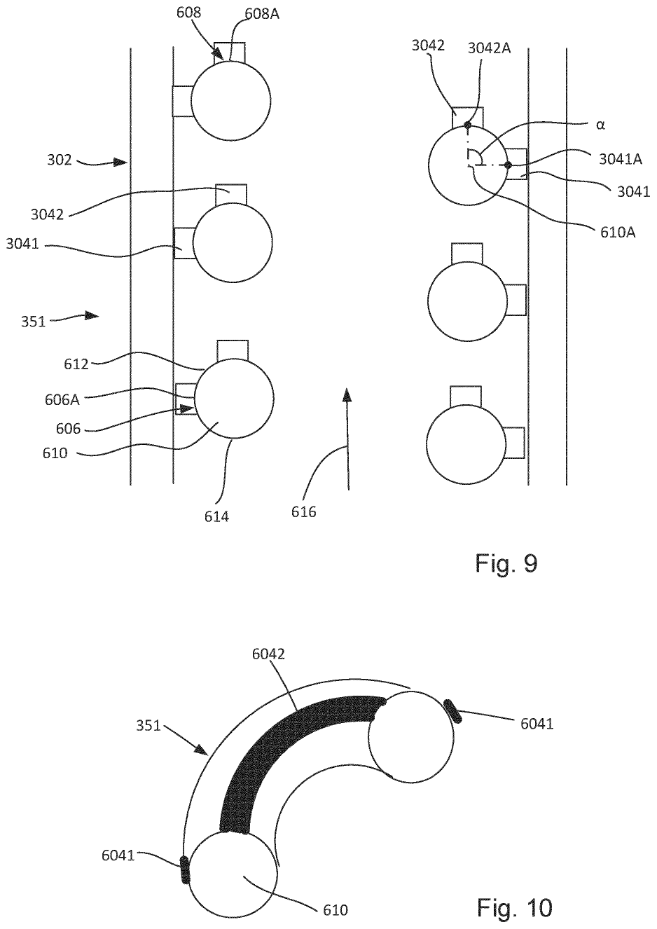

With reference to FIGS. 9 to 12, FIG. 9 shows a sectional detail of second embodiment of the heating coil 351 within part of the elongate housing 302. The section passes through the axis A of the elongate housing 302. FIG. 10 shows a perspective view of part of the coil 351.

The heating coil 351 is formed from a length of heating material 610 which has a circular cross-sectional profile. The surface of the length of heating material 610 has a first area 606 which includes the radially outermost part 606A of the coil 351, a second area 608 which faces the adjacent turn or loop of the coil 351 in the direction of the arrow 616 and includes the part 608A which is the closest part of the length of heating material to the adjacent turn of the coil, and a third area made up of areas 612 and 614 which include the remainder of the surface of the length of heating material that is not in areas 606 and 608. For clarity, not all parts of the length of heating material are labelled on each section of the length of heating material in FIG. 9.

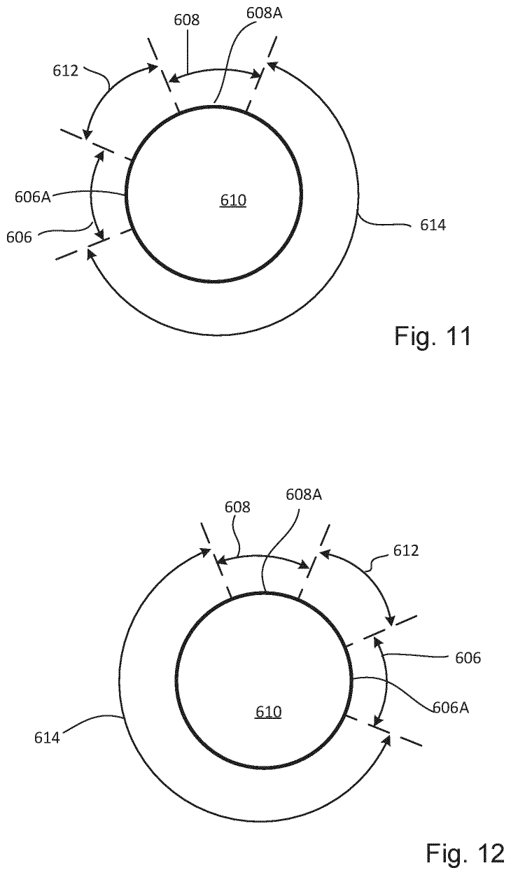

FIGS. 11 and 12 are schematic cross sections of the length of heating material 610 showing the location and circumferential extent of the areas 606, 608, 612, and 614 on the left hand side and right hand side of FIG. 9 respectively.

The first area 606 of the length of heating material 610 is the first area because it includes part 606A which is the part of the length of heating material 610 that could touch the housing body 306 unless prevented from doing so.

The second area 608 of the length of heating material 610 is the second area because it includes part 608A which is the part of the length of heating material 610 which could touch part of area 614 if the coil 351 were subject to a longitudinal force in the direction of arrow 616 or the opposite direction. In other embodiments the second area could be diagonally opposite the second area 608.

Supported on the first and second areas 606, 608 are electrical insulators 6041, 6042 respectively. The electrical insulator 6041 prevents the part 606A and the first area 606 touching the housing body 306. The electrical insulator 6042 prevents the part 608A and the second area 608 from touching the area 614.

The third and fourth areas 612, 614 of the length of heating material 610 are the third surface area and do not support any electrical insulator.

As shown in FIG. 9, the electrical insulators 3041, 3042 have a central axis 3041A, 3042A respectively. The central axes 3041A, 3042A extend along the angular centre of the electrical insulators 3041, 3042 around the longitudinal axis 610A of the length of heating material 610. The angular spacing a between the central axes 3041A, 3042A is around 90 degrees. In the illustrated embodiment the position of central axes 3041A, 3042A coincide with the position of parts 606A, 608A respectively. In other embodiments the position of central axes 3041A, 3042A may not coincide with the position of parts 606A, 608A respectively.

The length of heating material 610 is formed from a resistive material, such as a nickel/chrome alloy such as nichrome 80/20(80% Nickel, 20% Chromium), an iron/chrome /aluminium alloy, or a copper/nickel alloy.

The heating arrangement 300 comprises electrical connection paths 352, 353. The electrical connection paths extend from each end of the length of heating material 610 and connect the length of heating material 610 to components that may cause the length of heating material 610 to generate heat. In other embodiments, the electrical connection paths are integrally formed with the heating element, for example as a single wire. In embodiments, connectors connect the electrical connection paths with the heating element 350.

In the above described embodiments, the heating arrangement is a resistive heating arrangement. In embodiments, other types of heating arrangement are used, such as inductive heating. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heater of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A heater for an aerosol provision device configured to heat an article containing aerosol generating material, in which the heater comprises:
an elongate housing with an inner surface, and a heating coil in the housing, wherein the heating coil comprises a length of heating material shaped into a coil;
a surface of the length of the heating material comprises a first area, a second area, and a third area;
wherein
the first area comprises the part of the surface which could touch the inner surface of the housing when the heating coil is located within the inner housing;
the second area comprises a part of the surface which could touch another part of the surface of the heating material when the heating coil is located within the inner housing;
the third area comprises the part of the surface which could not touch either of the inner surface of the housing or another part of the surface of the length of heating material when the heating coil is located within the inner housing;
at least one of the first and second areas supports an electrical insulator; and
at least part of the third area does not support an electrical insulator.

2. The heater according to claim 1, in which both of the first and second areas support an electrical insulator.

3. A heater for an aerosol provision device configured to heat an article containing aerosol generating material, in which the heater comprises:
an elongate housing with an inner surface, and a heating coil in the housing, wherein
the heating coil comprises a length of heating material shaped into a coil;
a surface of the length of the heating material comprises a first area, a second area, and a third area;
an electrical insulator is provided on at least one of the first area and the second area of the heating material; and
wherein the third area of the heating material is spaced from the inner surface of the housing and is free from an electrical insulator.

4. The heater according to claim 3, in which the electrical insulator spaces the first area of the length of the heating material from the inner surface of the housing.

5. The heater according to claim 3, in which the electrical insulator spaces each part of the second area of the heating material from at least one of each other part of the second area, the first area, and the third area of the heating material.

6. The heater according to claim 3, in which the first and second areas are contiguous.

7. (canceled)

8. (canceled)

9. The heater according to claim 3, in which the heater is a resistive heating heater, and the length of heating material is a length of resistive heating material.

10. The heater according to claim 3, in which the elongate housing comprises an outer surface; in which at least a part of the outer surface of the elongate housing supports a low friction material; and the low friction material has a lower coefficient of friction than the outer surface of the housing.

11. (canceled)

12. (canceled)

13. A length of heating material for use in making a heater coil for use in a heater according to claim 3, in which
an electrical insulator is supported on at least one longitudinally extending area of the surface of the length of heating material,
at least one longitudinally extending area of the surface of the length of heating material is free from electrical insulator, and
the at least one longitudinally extending area on which the electrical insulator is supported is so dimensioned and positioned on the surface of the length of heating material that the when the length of heating material is formed into a coil having a longitudinal extent, the electrical insulator can be positioned relative to the coil so that the electrical insulator spaces the heating material from one or both of: an adjacent turn of the coil, and a flat surface outside the coil that extends in a direction parallel to the longitudinal extent of the coil.

14. The length of heating material according to claim 13, in which the at least one longitudinally extending area of the surface of the length of heating material that supports the electrical insulator comprises two non-contiguous longitudinally extending areas of the surface of the length of heating material.

15. The length of heating material according to claim 14, in which the length of heating material has a longitudinally extending axis,
the two longitudinally extending areas of the surface of the length of heating material that support the electrical insulator each have a longitudinally extending axis,
and the longitudinally extending axes of the areas of the surface of the length of heating material that support the electrical insulator are angularly spaced from each other around the longitudinally extending axis of the length of heating material by at least one of between 65 and 115 degrees, between 75 and 105 degrees, between 80 and 100 degrees, and between 85 and 95 degrees.

16. The length of heating material according to claim 13, in which the at least one longitudinally extending areas of the surface of the length of heating material to which the electrical insulator is applied have a total area of less than or equal to 55% of the total surface area of the length of heating material.

17. (canceled)

18. A method of making a length of heating material according to claim 13, in which
a length of heating material is provided,
an electrical insulator is applied to at least one longitudinally extending area of the surface of the length of heating material,
keeping at least one longitudinally extending area of the surface of the length of heating material free from electrical insulator, and
the length of heating material is shaped into a coil.

19. The method according to claim 18, in which the electrical insulator is applied to the at least one longitudinally extending area during the process of shaping the length of heating material into the coil.

20. The method according to claim 18, in which the electrical insulator is applied as a liquid coating, as a part of a plating process, as a part of a vapour deposition process, or as a part of an anodising process.

21. The method according to claim 18, in which the at least one longitudinally extending area of the surface of the length of heating material to which the electrical insulator is applied is less than or equal to 55% of the total surface area of the length of heating material.

22. The method according to claim 18 in which the at least one longitudinally extending area of the surface of the length of heating material to which the electrical insulator is applied comprises two non-contiguous longitudinally extending areas of the surface of the length of heating material.

23. An aerosol provision device configured to heat an article to generate an aerosol comprising a heater according to claim 3.

24. A system comprising the heater according to claim 3 and an article comprising aerosol generating material.

25. A method of generating aerosol comprising: providing an aerosol provision device comprising a heater according to claim 3 and a heating chamber including a receiving portion; and at least partially inserting an aerosol generating article into the receiving portion of the heating chamber.
